(19) United States
(12) Patent Application Publication
(10) Pub. No.: US 2015/0002954 A1
(43) Pub. Date: Jan. 1, 2015

(54) EXTERIOR REARVIEW MIRROR ASSEMBLY

(71) Applicant: MAGNA MIRRORS OF AMERICA, INC., HOLLAND, MI (US)

(72) Inventors: Niall R. Lynam, Holland, MI (US); Michael J. Baur, Holland, MI (US)

(21) Appl. No.: 14/312,057

(22) Filed: Jun. 23, 2014

Related U.S. Application Data
(60) Provisional application No. 61/839,585, filed on Jun. 26, 2013.

(51) Int. Cl. B60R 1/08; B24B 13/01; G02B 1/10; G02B 5/08; G02B 5/10

(52) U.S. Cl. CPC B60R 1/082; G02B 5/0808; G02B 5/10; G02B 1/10; B24B 13/01
USPC 359/866; 427/162; 451/41

(57) ABSTRACT

An exterior rearview mirror assembly for a vehicle includes a mirror reflective element having a glass substrate with a rear surface and a front surface that is closer to the driver of the vehicle than the rear surface when the rearview mirror assembly is mounted at a vehicle. The mirror reflective element includes a generally planar principal reflecting portion and an angled reflecting portion, with the angled reflecting portion established at an inboard region of the mirror reflective element. The angled reflecting portion is established by grinding a surface of the glass substrate at the inboard region. A mirror reflector is established at the angled reflecting portion, and a mirror reflector is established at the principal reflecting portion to provide a unit magnification principal reflecting portion of the mirror reflective element.

### CROSS REFERENCE TO RELATED APPLICATION

The present application claims the filing benefits of U.S. provisional application Ser. No. 61/839,585, filed Jun. 26, 2013, which is hereby incorporated herein by reference in its entirety.

### FIELD OF THE INVENTION

The present invention relates generally to the field of rearview mirror assemblies for vehicles.

### BACKGROUND OF THE INVENTION

It is known to provide an automotive rearview mirror assembly that includes one or more accessories, such as a light source and/or a user input or the like. The mirror reflective element of such known mirror assemblies may include visual indicators such as turn signal indicators and blind zone indicators that indicate to a driver presence of another overtaking vehicle in a side lane adjacent to the equipped vehicle. The mirror reflective element and/or mirror assembly may include a wide angle spotter mirror at an outboard portion of the mirror reflective element.

### SUMMARY OF THE INVENTION

The present invention provides a rearview mirror assembly (such as an exterior mirror assembly mounted at a side of an equipped vehicle) that includes a mirror reflective element having generally planar or flat glass mirror substrate with an inboard curved wider angled mirror portion. When the mirror reflective element is adjusted to provide the driver with an appropriate field of view that encompasses a blind spot area at the side and rearward of the vehicle, the inboard curved reflective surface provides a wide angle field of view that encompasses a side portion of the vehicle at the side at which the mirror assembly is mounted, while the planar or non-curved portion of the reflective element provides the desired rearward and sideward field of view at the side and rear of the vehicle. The mirror reflective element comprises a flat or planar or substantially flat or planar glass substrate of unit magnification that is fully compliant with FMVSS 111, with the inboard region of the glass substrate ground or partially removed to the desired radius of curvature and coated with a reflector coating to establish the curved reflective surface but, importantly, with the outboard flat or planar portion entirely unbent and of unit magnification. Thus, the principal reflecting portion of the mirror reflective element comprises a planar or flat unit magnification rearward field of view, while the ground inboard curved reflective surface allows for the driver to adjust the rearward field of view further outboard of the side of the vehicle while still maintaining a vehicle reference (a portion of the side of the vehicle) in the driver's rearward field of view.

Optionally, a camera may be provided at the side of the vehicle (such as at or in the mirror assembly) that is adjustably mounted at the side of the vehicle and that is adjustable to adjust its principal viewing angle, such as in response to the current driving situation or condition of the vehicle. For example, the camera may be adjusted to view generally rearwardly when the vehicle is being normally driven along a road, and may be adjusted to view generally downwardly during a parking maneuver of the vehicle.

These and other objects, advantages, purposes and features of the present invention will become apparent upon review of the following specification in conjunction with the drawings.

### BRIEF DESCRIPTION OF THE DRAWINGS

FIG. 1 is a view of an exterior rearview mirror assembly in accordance with the present invention;

FIG. 2 is a plan view of a mirror reflective element having a curved inboard reflective surface in accordance with the present invention;

FIG. 3 is a sectional view of the mirror reflective element of FIG. 2;

FIG. 4 is a view of an exemplary mirror reflective element of the present invention;

FIG. 5 is a sectional view of another mirror reflective element of the present invention, with a smaller generally spherically shaped curved inboard reflective surface;

FIG. 6 is a sectional view of another mirror reflective element of the present invention, with a flat angled inboard reflective surface; and

FIG. 7 is a view of another exterior rearview mirror assembly, shown with a camera adjustably mounted at the mirror assembly in accordance with the present invention.

### DESCRIPTION OF THE PREFERRED EMBODIMENTS

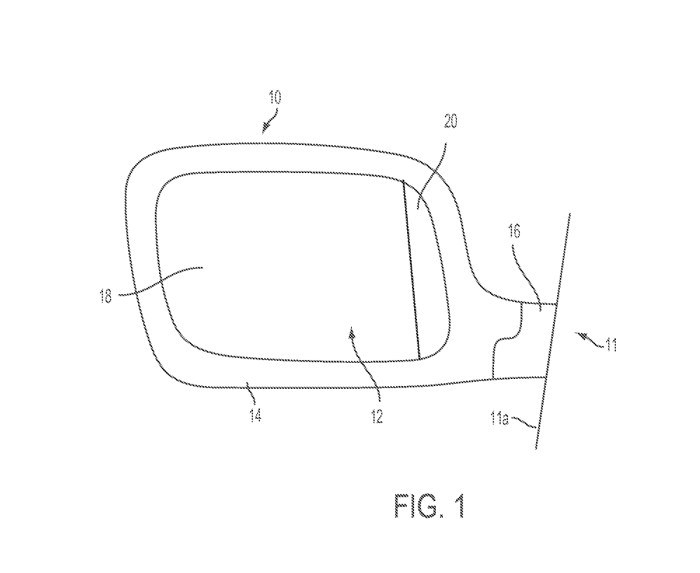

Referring now to the drawings and the illustrative embodiments depicted therein, an exterior rearview mirror assembly 10 for a vehicle 11 includes a mirror reflective element 12 received in and/or supported at or by a mirror shell or casing or head portion 14 (FIG. 1). The mirror casing or head portion 14 may be fixedly attached at a mounting arm or base 16 at the side of the vehicle or may be movably mounted to a mounting arm or base or portion 16, and may comprise a breakaway mirror (where the mirror head portion may be manually pivoted about the mounting arm or base) or may comprise a powerfold mirror (where the mirror head portion may be pivoted via an actuator assembly or adjustment device). Mounting arm or base 16 of mirror assembly 10 is mounted at the side 11a of a host or subject vehicle 11, with the reflective element 12 providing a rearward field of view along the respective side of the vehicle to the driver of the vehicle, as discussed below.

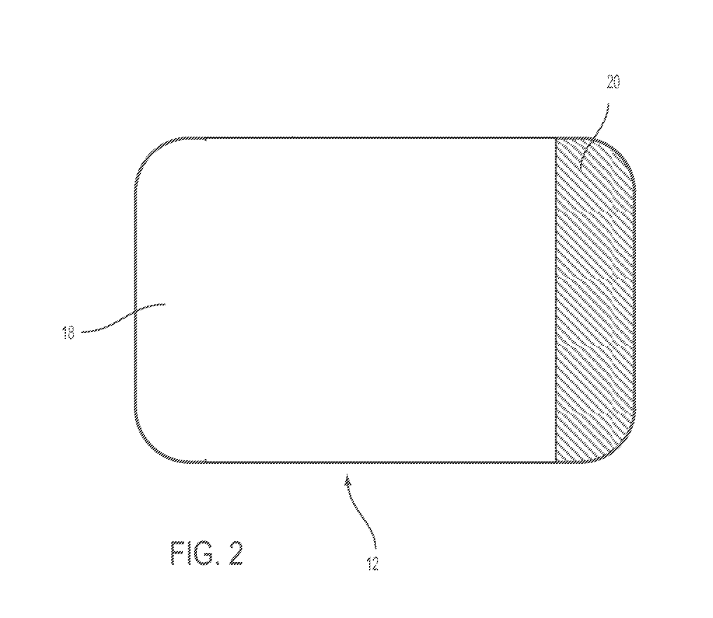

The mirror reflective element 12 comprises a planar or flat glass substrate coated on its outer surface with a mirror reflector coating. As shown in FIGS. 1 and 2, the mirror reflective element 12 includes a planar or flat or unit magnification principal reflecting or viewing portion 18 and an inboard curved wide angle reflecting or viewing portion 20, as discussed below.

Typically, and in the United States in particular, an exterior rearview mirror reflective element must be flat and have unit magnification. It has been proposed (such as in U.S. Pat. No. 6,522,451, which is hereby incorporated herein by reference in its entirety) to provide a partially bent glass substrate to provide a wide angle field of view outboard or inboard of the plano portion of the reflective element. However, when flat glass is bent even at one or more of its edge regions, the bending invariably distorts the flatness of the glass.

When adjusting the mirror reflective element to provide a desired rearward field of view for the driver of the vehicle, many people set the reflective element so that the rearward field of view includes a portion of the side of the vehicle as a reference. However, for enhanced viewing of the blind spot regions sideward and rearward of the vehicle, the mirror reflective element should be adjusted so that its rearward field of view (to the driver when the driver is normally operating the vehicle) is further outboard and does not include any portion of the side of the vehicle.

The reflective element of the present invention provides a mirror structure that allows for a more outboard setting of the field of view, while providing for viewing of the vehicle side reference, and without affecting or distorting the flatness or unit magnification of the principal reflecting portion of the reflective element. The mirror reflective element of the present invention includes an inboard region that has a ground curved surface (ground from a flat glass substrate that is flat across its entire outer surface), which has a mirror reflector coating established at the curved ground surface. Thus, the mirror reflective element of the present invention has a wide angle inboard portion and a planar principal portion (with the flatness or unit magnification of the principal portion not disturbed by the grinding of the inboard portion). The outer flat surface and the inboard ground (and polished) surface are coated with a mirror reflector coating to provide the desired reflectance across the reflective element. The mirror reflector coating may comprise a common reflector coating at both the inboard curved or angled region and the generally planar principal portion or region (with the mirror reflector coating commonly established at the glass substrate via a common or single mirror reflector coating process, such as via a vacuum deposition process or the like), or the reflective element may have separate mirror reflector coatings established at respective portions or regions of the glass substrate.

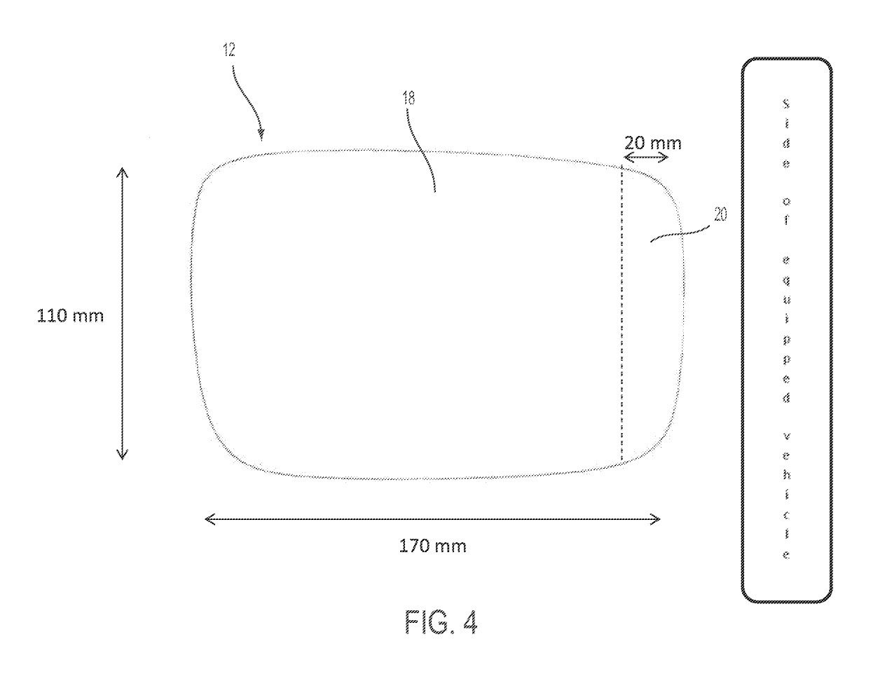

The size of the reflective element (height and width) may be any suitable size (depending on the application) and, for example, may have a width dimension “E” of at least about 160 mm, preferably at least about 180 mm and a height dimension of at least about 100 mm, preferably at least about 130 mm. The flat or unit magnification principal reflecting portion comprises a substantial portion of the reflective element, such as a portion having a width “C” of at least about 140 mm, preferably at least about 160 mm or thereabouts. The width dimension “B” of the curved or ground inboard region or viewing portion 20 may be around 10 to 30 mm or thereabouts. Thus, and as shown in FIG. 4, an exemplary mirror reflective element 12, such as a reflective element suitable for use in, for example, an Acura vehicle or the like, has a width dimension of about 170 mm and a height dimension of about 110 mm, with an inboard wide angle reflective portion having a width dimension of about 20 mm or thereabouts.

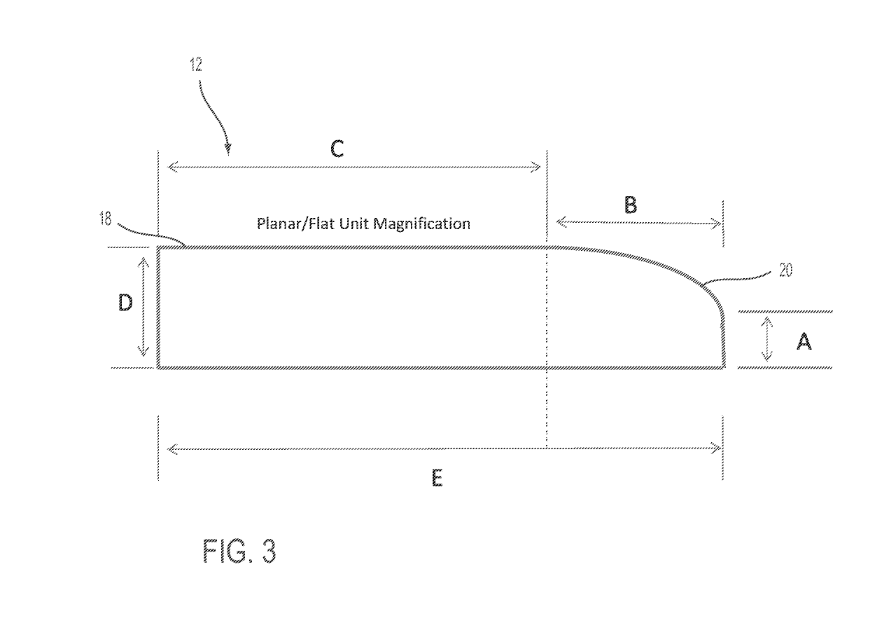

As can be seen with reference to FIG. 3, the reflective element 12 may comprise a flat or planar glass substrate 22 having a thickness “D” of at least about 2.3 mm, such as around 3 mm or less. The inboard region or portion 20 may be ground so that the inboard edge thickness dimension “A” is preferably at least about 0.5 mm, more preferably at least about 0.75 mm, such as about 1 mm or thereabouts. The ground curvature may provide a spherical or partial spherical curvature at the inboard region or may provide a non-spherical curvature (such as shown in FIG. 3), and may curve so that its outboard region is tangent to or coplanar with the flat outer surface of the planar or flat or unit magnification portion 18 of the reflective element.

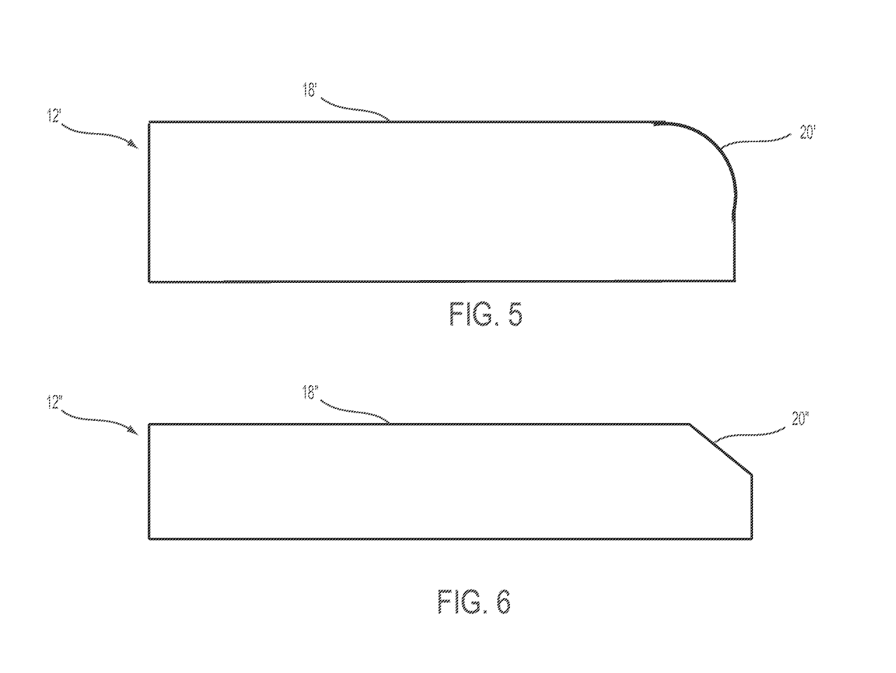

Optionally, although shown and described as having the ground curved or radiused inboard portion of FIG. 3, a reflective element 12′ (FIG. 5) may have a generally planar or flat or unit magnification portion 18′ and an inboard generally spherically curved or constant radius curved portion 20′ or other curvature or shape, depending on the particular application of the mirror assembly. Optionally, a reflective element 12″ (FIG. 6) of the present invention may have a generally planar or flat or unit magnification portion 18″ and a ground chamfered or flat/angled inboard portion 20″ to provide the desired inboard field of view to the driver of the vehicle while allowing the driver to adjust the reflective element for an appropriate outboard field of view. Preferably, the inboard portion is curved to provide a wider inboard field of view and a smooth transition to the principal unit magnification portion, so the driver can adjust the reflective element for a greater outboard field of view while achieving the reference point of the side of the vehicle in his or her rearward field of view. Optionally, it is envisioned that the rear surface of the flat glass substrate may have a bevel or curve established at the inboard region, and the curved or beveled rear surface may be coated with the mirror reflector to achieve the inboard wide angle reflector portion of the reflective element without distorting or effecting the flat or planar or unit magnification of the principal reflecting portion of the reflective element.

Optionally, the exterior rearview mirror assembly may include a camera disposed thereat that is operable to capture image data exterior of the vehicle. For example, the camera may be part of a blind spot detection system or rear vision system and may have its field of view directed generally rearward with respect to the vehicle. Optionally, the camera may be part of a surround view or bird's eye view display system and may have its field of view generally downward, with a wide angle or fisheye lens that views downwardly and forwardly and rearwardly to capture the area sideward of the vehicle. Optionally, such a camera or cameras may be disposed at a side region of the vehicle and may not be part of an exterior rearview mirror assembly and may obviate the need for an exterior rearview mirror assembly (see, for example, U.S. Pat. Nos. 5,670,935, which is hereby incorporated herein by reference in its entirety).

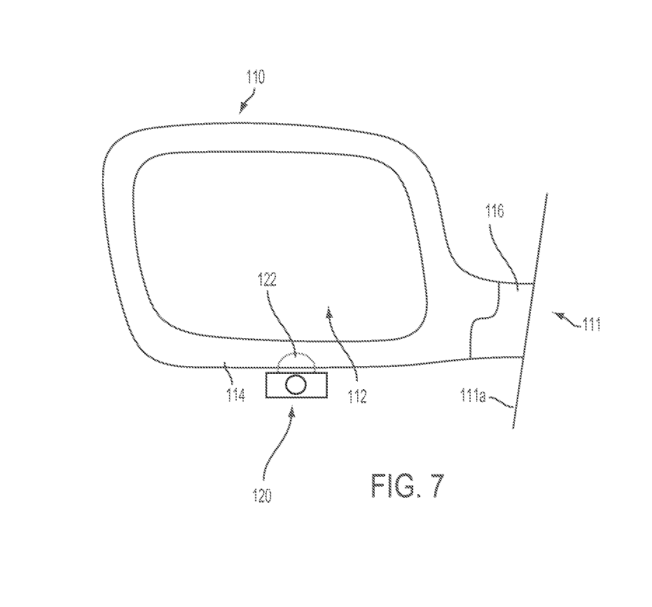

Optionally, a camera assembly or unit or module or system of the present invention may comprise a single camera that is adjustably disposed at a side region of a vehicle and is adjustable to capture image data when set at a generally rearward field of view and/or a generally downward field of view and/or other suitable fields of view. For example, and such as shown in FIG. 7, a camera 120 may be disposed at a mirror assembly 110 (which includes a mirror head 114 (having a mirror reflective element 112) mounted at a mounting arm 116 that is attached at a side 111a of a vehicle 111), and the camera is adjustably mounted at the mirror assembly and is adjustable to change its field of view, such as in accordance with the driving condition of the vehicle.

In the illustrated embodiment, the camera 120 is adjustably mounted at the mirror head 114 via a ball joint or gimbal or multi-axis mounting joint or element 122 so that the camera is adjustable to move the principal viewing axis of the camera in a lateral direction (such as by rotating the camera about a generally vertical axis) or a vertical direction (such as by rotating the camera about a generally horizontal axis) or optionally any other adjustments about other axes. Although shown and described as being adjustably mounted at the mirror head, an adjustable camera of the camera system of the present invention may be mounted at the side of the vehicle and may obviate the need for an exterior rearview mirror at that side of the vehicle.

The camera of the present invention is adjustable relative to the vehicle in response to or in association with the current driving situation or condition of the vehicle. For example, when the vehicle is being driven in a forward direction along a road, the camera (such as responsive to the vehicle being in a forward gear and/or moving at or above a threshold speed or the like) may swivel or may be set so as to face generally rearwardly, whereby images (such as video images) derived from captured image data may be displayed at a display that is viewable by the driver to provide the driver with a generally rearward field of view at the side of the vehicle (so as to allow the driver to see other vehicles at the side and/or rear of the driven vehicle as the driver drives the vehicle along the road). Optionally, for example, when the driver is parking the vehicle, the camera (such as responsive to the vehicle shifted into reverse or traveling below a threshold speed or the like) may swivel or adjust to view generally downwardly to provide an output for a surround view or bird's eye view display system of the vehicle (and may adjust or swivel partially forwardly or rearwardly from its generally downward viewing direction as the vehicle is driven forwardly or rearwardly during the parking maneuver to enhance the respective viewing direction), so as to assist the driver during the parking maneuver of the vehicle. Optionally, the camera may be adjusted for other driving conditions or may be selectively adjusted responsive to a user input (such as a joystick or toggle or the like) that allows the driver to manually adjust or swivel the camera to capture image data at a selected viewing angle at the side of the vehicle.

The system is operable to display images, such as video images or the like, representative of image data captured by the camera or cameras, for viewing by the driver of the vehicle when normally operating the vehicle. For example, the vehicle may include one or more displays, such as the types disclosed in U.S. Pat. Nos. 5,530,240 and/or 6,329,925, which are hereby incorporated herein by reference in their entireties, and/or display-on-demand transflective type displays, and/or video displays or display screens, such as the types disclosed in U.S. Pat. Nos. 7,855,755; 7,338,177; 7,274,501; 7,255,451; 7,195,381; 7,184,190; 7,046,448; 5,668,663; 5,724,187; 5,530,240; 6,329,925; 6,690,268; 7,734,392; 7,370,983; 6,902,284; 6,428,172; 6,420,975; 5,416,313; 5,285,060; 5,193,029 and/or 4,793,690, and/or U.S. patent application Ser. No. 13/023,750, filed Feb. 9, 2011 (Attorney Docket DON01 P-1679); Ser. No. 09/585,379, filed Jun. 1, 2000, now abandoned; and/or Ser. No. 10/207,291, filed Jul. 29, 2002, now abandoned, and/or U.S. Pat. Pub. Nos. US-2006-0061008, US-2006-0050018, US-2009-0015736, US-2009-0015736 and/or US-2010-0097469, and/or International Publication No. WO 2011/028686, which are all hereby incorporated herein by reference in their entireties.

The video display screen may be controlled or operable in response to an input or signal, such as a signal received from one or more cameras or image sensors of the vehicle, such as a video camera or sensor, such as a CMOS imaging array sensor, a CCD sensor or the like, and image processors or image processing techniques, such as utilizing aspects of the cameras and image processors described U.S. Pat. Nos. 5,550,677; 5,670,935; 5,760,962; 6,498,620; 6,396,397; 6,222,447; 6,201,642; 6,097,023; 5,877,897; 5,796,094; 5,715,093; 6,922,292; 6,757,109; 6,717,610; 6,590,719; 6,320,176; 6,559,435; 6,831,261; 6,806,452; 6,822,563; 6,946,978; 7,038,577; 7,004,606 and/or 7,720,580, and/or U.S. Pat. Pub. Nos. US-2006-0171704, US-2009-0244361 and/or US-2010-0214791, and/or International Publication Nos. WO 2009/046268 and/or WO 2009/036176, and/or U.S. provisional application Ser. No. 61/839,110, filed Jun. 25, 2013 (Attorney Docket DON09 P-2122), which are hereby incorporated herein by reference in their entireties, or from one or more imaging systems of the vehicle, such as a reverse or backup aid system, such as a rearwardly directed vehicle vision system utilizing principles disclosed in U.S. Pat. Nos. 5,550,677; 5,760,962; 5,670,935; 6,201,642; 6,396,397; 6,498,620; 6,717,610 and/or 6,757,109, which are hereby incorporated herein by reference in their entireties, a trailer hitching aid or tow check system, such as the type disclosed in U.S. Pat. No. 7,005,974, which is hereby incorporated herein by reference in its entirety, a cabin viewing or monitoring device or system, such as a baby viewing or rear seat viewing camera or device or system or the like, such as disclosed in U.S. Pat. Nos. 5,877,897 and/or 6,690,268, which are hereby incorporated herein by reference in their entireties, a video communication device or system, such as disclosed in U.S. Pat. No. 6,690,268, which is hereby incorporated herein by reference in its entirety, and/or the like. The imaging sensor or camera may be activated and the display screen may be activated in response to the vehicle shifting into reverse, such that the display screen is viewable by the driver and is displaying an image of the rearward scene while the driver is reversing the vehicle. It is envisioned that an image processor or controller (such as an EyeQ™ image processing chip available from Mobileye Vision Technologies Ltd. of Jerusalem, Israel, and such as an image processor of the types described in International Pub. No. WO/2010/099416, which is hereby incorporated herein by reference in its entirety) may process image data captured by the camera or cameras, such as for object detection or assessment of lighting conditions and/or the like.

Optionally, the imaging sensor (such as a sideward and/or rearward facing imaging sensor or camera that has a sideward/rearward field of view at the side of the vehicle at which the exterior mirror assembly is mounted) may be part of or may provide an image output for a vehicle vision system, such as a lane departure warning system or object detection system or blind zone alert system or surround view vision system other vehicle vision system or the like, and may utilize aspects of various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 6,498,620; 6,396,397; 6,222,447; 6,201,642; 6,097,023; 5,877,897; 5,796,094; 5,715,093; 6,922,292; 6,757,109; 6,717,610; 6,590,719; 6,320,176; 6,559,435; 6,831,261; 6,806,452; 6,822,563; 6,946,978; 7,038,577; 7,004,606 and/or 7,720,580, which are all hereby incorporated herein by reference in their entireties. Optionally, for example, the vehicle vision system (utilizing a forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described International Publication Nos. WO 2010/099416; WO 2011/028686; WO 2012/075250; WO 2013/019795; WO 2012-075250; WO 2012/154919; WO 2012/0116043; WO 2012/0145501; WO 2012/0145313; WO 2012/145822; WO 2013/081985; WO 2013/086249 and/or WO 2013/109869, and/or U.S. patent application Ser. No. 13/333,337, filed Dec. 21, 2011 (Attorney Docket DON01 P-1797), which are hereby incorporated herein by reference in their entireties.

Optionally, the exterior mirror element of an mirror assembly may include heater pad or film or element at a rear surface of the mirror reflective element. The heater pad or element at the rear surface of the glass substrate may comprise a mirror defrost/demisting heater and may provide an anti-fogging of de-fogging feature to the exterior mirror assembly, and may utilize aspects of the heater elements or pads described in U.S. Pat. Nos. 8,058,977; 7,400,435; 5,808,777; 5,610,756 and/or 5,446,576, and/or U.S. Pat. Publication No. 20080011733 and/or U.S. patent application Ser. No. 13/111,407, filed May 19, 2011 (Attorney Docket DON09 P-1710), which are hereby incorporated herein by reference in their entireties. The heater element may include electrical contacts that extend rearward therefrom and through an aperture of attaching portion of back plate for electrical connection to a wire harness or connector of the mirror assembly, or the back plate and/or heater pad may include suitable electrical connectors and connections incorporated therein (such as by utilizing aspects of the mirror assembly described in U.S. Pat. No. 7,400,435, which is hereby incorporated herein by reference in its entirety) for electrically connecting the heater pad (or other suitable electrical connectors may be utilized, such as electrical leads or wire harnesses or pigtails or other separate connectors or cables or the like). Optionally, the heater pad may comprise a screen printed heater pad. For example, the heater pad can be printed on the back of the mirror reflective element (such as at the fourth or rear surface of the rear substrate). Such coatings may be printed and then cured at around 120 degrees C. or lower, making this process compatible with already formed laminate type EC mirror elements, such as those described in U.S. Pat. No. 5,724,187, which is hereby incorporated herein by reference in its entirety. This would make it compatible with EC mirrors.

The mirror assembly may comprise any suitable construction, such as, for example, a mirror assembly with the reflective element being nested in the mirror casing and with the mirror casing having a curved or beveled perimeter edge around the reflective element and with no overlap onto the front surface of the reflective element (such as by utilizing aspects of the mirror assemblies described in U.S. Pat. Nos. 7,255,451; 7,289,037; 7,360,932; 8,049,640; 8,277,059 and/or 8,529,108, which are hereby incorporated herein by reference in their entireties, or such as a mirror assembly having a rear substrate of an electro-optic or electrochromic reflective element nested in the mirror casing, and with the front substrate having curved or beveled perimeter edges, or such as a mirror assembly having a prismatic reflective element that is disposed at an outer perimeter edge of the mirror casing and with the prismatic substrate having curved or beveled perimeter edges, such as described in U.S. Des. Pat. Nos. D633,423; D633,019; D638,761 and/or D647,017, and/or International Publication Nos. WO 2010/124064, WO 2011/044312, WO 2012/051500, WO 2013/071070 and/or WO 2013/126719, which are hereby incorporated herein by reference in their entireties (and with electrochromic and prismatic mirrors of such construction are commercially available from the assignee of this application under the trade name INFINITY™ mirror).

Optionally, the mirror assembly may include a blind spot indicator and/or a turn signal indicator, such as an indicator or indicators of the types described in U.S. Pat. Nos. 6,198,409; 5,929,786; and 5,786,772, and/or International Publication Nos. WO 2007/005942 and/or WO 2008/051910, which are hereby incorporated herein by reference in their entireties. The signal indicator or indication module may include or utilize aspects of various light modules or systems or devices, such as the types described in U.S. Pat. Nos. 7,581,859; 6,227,689; 6,582,109; 5,371,659; 5,497,306; 5,669,699; 5,823,654; 6,176,602 and/or 6,276,821, and/or U.S. patent application Ser. No. 13/891,619, filed May 10, 2013 (Attorney Docket DON09 P-2058); and/or Ser. No. 13/249,433, filed Sep. 30, 2011, now U.S. Pat. No. 8,764,256, and/or International Publication No. WO 2006/124682, which are all hereby incorporated herein by reference in their entireties.

Such an indicator or indicators may function as a lane change assist (LCA) indicator or indicators and/or a blind spot indicator or indicators. Such blind spot indicators are typically activated when an object is detected (via a side object or blind spot detection system or the like such as described in U.S. Pat. Nos. 7,038,577; 6,882,287; 6,198,409; 5,929,786; 5,786,772; and/or 7,720,580; and/or International Publication No. WO 2007/005942, which are hereby incorporated herein by reference in their entireties) at the side and/or rear of the vehicle (at the blind spot) and when the turn signal is also activated, so as to provide an alert to the driver of the host vehicle that there is an object or vehicle in the lane next to the host vehicle at a time when the driver of the host vehicle intends to move over into the adjacent lane. Optionally, and alternately, the indicator or indicators may function as a lane change assist indicator or indicators, where the host vehicle may be detected to be moving into an adjacent lane without the turn signal being activated, and an object or vehicle may be detected at the adjacent lane, whereby the LCA indicator or indicators may be activated to provide an alert to the driver of the lane change to assist the driver in avoiding unintentional lane changes and/or lane changes when a vehicle or object is detected in the adjacent lane.

The blind spot indicators thus may be operable to provide an indication to the driver of the host vehicle that an object or other vehicle has been detected in the lane or area adjacent to the side of the host vehicle. The blind spot indicator may be operable in association with a blind spot detection system, which may include an imaging sensor or sensors, or an ultrasonic sensor or sensors, or a sonar sensor or sensors or the like. For example, the blind spot detection system may utilize aspects of the blind spot detection and/or imaging systems described in U.S. Pat. Nos. 7,038,577; 6,882,287; 6,198,409; 5,929,786; 5,786,772; 7,881,496; and/or 7,720,580, and/or of the reverse or backup aid systems, such as the rearwardly directed vehicle vision systems described in U.S. Pat. Nos. 5,550,677; 5,760,962; 5,670,935; 6,201,642; 6,396,397; 6,498,620; 6,717,610 6,757,109; and/or 7,005,974, and/or of the automatic headlamp controls described in U.S. Pat. Nos. 5,796,094; 5,715,093; and/or 7,526,103, and/or of the rain sensors described in U.S. Pat. Nos. 6,250,148 and 6,341,523, and/or of other imaging systems, such as the types described in U.S. Pat. Nos. 6,353,392 and 6,313,454, which may utilize various imaging sensors or imaging array sensors or cameras or the like, such as a CMOS imaging array sensor, a CCD sensor or other sensors or the like, such as the types disclosed in commonly assigned, U.S. Pat. Nos. 5,550,677; 5,760,962; 6,097,023 and/or 5,796,094, and/or PCT Application No. PCT/US2003/036177 filed Nov. 14, 2003, published Jun. 3, 2004 as International Publication No. WO 2004/047421, with all of the above referenced U.S. patents, patent applications and PCT applications being commonly assigned and being hereby incorporated herein by reference in their entireties.

The reflective element of the rearview mirror assembly of vehicles may include an auxiliary wide angle or spotter mirror portion, such as the types described in U.S. Pat. Nos. 7,255,451; 7,195,381; 6,717,712; 7,126,456; 6,315,419; 7,097,312; 6,522,451; 6,315,419; 5,080,492; 5,050,977; and/or 5,033,835, which are hereby incorporated herein by reference in their entireties, and optionally may have an integrally formed auxiliary mirror reflector, such as the types described in U.S. Pat. Nos. 8,736,940; 8,021,005; 7,934,844; 7,887,204; 7,824,045; and 7,748,856, which are hereby incorporated herein by reference in their entireties. The auxiliary wide angle optic may be integrally formed such as by physically removing, such as by grinding or ablation or the like, a portion of the second surface of the front substrate so as to create or establish a physical dish-shaped generally convex-shaped depression or recess or crater at the second surface of the front substrate, and coating the formed depression or recess with a reflector coating or element or the like, such as described in U.S. Pat. No. 8,021,005, incorporated above. The mirror reflective element includes a demarcating layer or band or element that is disposed or established around the perimeter of the reflective element and around the perimeter of the spotter mirror so as to demarcate the spotter mirror from the main reflector portion to enhance the viewability and discernibility of the spotter mirror to the driver of the vehicle, such as by utilizing aspects of the hiding layers described in U.S. Pat. No. 8,736,940, which is hereby incorporated herein by reference in its entirety. The demarcating layer or contrasting coating or layer or material may comprise any suitable material, and may provide a different color or reflectivity or may comprise a dark or opaque color to demarcate the spotter mirror and enhance discernibility of the spotter mirror from the main mirror, which may comprise a flat mirror, a convex mirror or a free form mirror (such as utilizing aspects of the mirrors described in U.S. patent application Ser. No. 13/942,751, filed Jul. 16, 2013 (Attorney Docket DON09 P-2102), which is hereby incorporated herein by reference in its entirety).

The mirror assembly may comprise an electro-optic or electrochromic mirror assembly that includes an electro-optic or electrochromic reflective element. The perimeter edges of the reflective element may be encased or encompassed by the perimeter element or portion of the bezel portion to conceal and contain and envelop the perimeter edges of the substrates and the perimeter seal disposed therebetween. The electrochromic mirror element of the electrochromic mirror assembly may utilize the principles disclosed in commonly assigned U.S. Pat. Nos. 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407 and/or 4,712,879, and/or International Publication No. WO 2010/114825, which are hereby incorporated herein by reference in their entireties, and/or as disclosed in the following publications: N. R. Lynam, “Electrochromic Automotive Day/Night Mirrors”, SAE Technical Paper Series 870636 (1987); N. R. Lynam, “Smart Windows for Automobiles”, SAE Technical Paper Series 900419 (1990); N. R. Lynam and A. Agrawal, “Automotive Applications of Chromogenic Materials”, Large Area Chromogenics: Materials and Devices for Transmittance Control, C. M. Lampert and C. G. Granquist, EDS., Optical Engineering Press, Wash. (1990), which are hereby incorporated by reference herein in their entireties; and/or as described in U.S. Pat. No. 7,195,381, which is hereby incorporated herein by reference in its entirety.

Optionally, it is envisioned that aspects of the present invention may be suitable for a rearview mirror assembly that comprises a non-electro-optic mirror assembly (such as a generally planar or optionally slightly curved mirror substrate) or an electro-optic or electrochromic mirror assembly. Optionally, the rearview mirror assembly may comprise a mirror assembly of the types described in U.S. Pat. Nos. 7,420,756; 7,289,037; 7,274,501; 7,338,177; 7,255,451; 7,249,860; 6,318,870; 6,598,980; 5,327,288; 4,948,242; 4,826,289; 4,436,371; and 4,435,042, which are hereby incorporated herein by reference in their entireties. A variety of mirror accessories and constructions are known in the art, such as those disclosed in U.S. Pat. Nos. 5,555,136; 5,582,383; 5,680,263; 5,984,482; 6,227,675; 6,229,319; and 6,315,421 (which are hereby incorporated herein by reference in their entireties), that can benefit from the present invention.

Optionally, the reflective element may includes an opaque or substantially opaque or hiding perimeter layer or coating or band disposed around a perimeter edge region of the front substrate (such as at a perimeter region of the rear or second surface of the front substrate) to conceal or hide or the perimeter seal from viewing by the driver of the vehicle when the mirror assembly is normally mounted in the vehicle. Such a hiding layer or perimeter band may be reflective or not reflective and may utilize aspects of the perimeter bands and mirror assemblies described in U.S. Pat. Nos. 5,066,112; 7,626,749; 7,274,501; 7,184,190; and/or 7,255,451, and/or International Publication Nos. WO 2010/124064 and/or WO 2011/044312, and/or U.S. Pat. Pub. No. US-2006-0061008, which are all hereby incorporated herein by reference in their entireties. Optionally, the perimeter band may comprise a chrome/chromium coating or metallic coating and/or may comprise a chrome/chromium or metallic coating that has a reduced reflectance, such as by using an oxidized chrome coating or chromium oxide coating or “black chrome” coating or the like (such as by utilizing aspects of the mirror assemblies described in U.S. Pat. No. 7,184,190 and/or 7,255,451, which are hereby incorporated herein by reference in their entireties). Optionally, other opaque or substantially opaque coatings or bands may be implemented while remaining within the spirit and scope of the present invention.

The mirror assembly may comprise or utilize aspects of other types of casings or the like, such as described in U.S. Pat. Nos. 7,338,177; 7,289,037; 7,249,860; 6,439,755; 4,826,289; and 6,501,387, which are all hereby incorporated herein by reference in their entireties, without affecting the scope of the present invention. For example, the mirror assembly may utilize aspects of the flush or frameless or bezelless reflective elements described in U.S. Pat. Nos. 7,626,749; 7,360,932; 7,289,037; 7,255,451; 7,274,501; and/or 7,184,190, and/or in U.S. Pat. Pub. Nos. US-2006-0061008 and/or US-2006-0050018, which are all hereby incorporated herein by reference in their entireties.

Optionally, the mirror assembly may comprise a modular mirror construction, and may include back housing portions or the like, such as cap portions of the types described in U.S. Pat. No. 7,289,037, which is hereby incorporated herein by reference in its entirety. A display screen may be provided as a modular display screen and may be mountable or installable in the appropriate or suitable mirror casing to provide a modular mirror assembly and display screen. For example, a rear casing or cap portion may include the display screen module including the associated components, such as the rails and motor and the like for a video slideout module (such as by utilizing aspects of the video mirrors described in U.S. Pat. Nos. 7,370,983 and 6,690,268, and/or U.S. Pat. Pub. Nos. US-2006-0050018 and/or US-2009-0015736, which are hereby incorporated herein by reference in their entireties), and may be attachable to a reflective element and/or mirror casing to assemble the modular mirror assembly. The display screen module thus may be provided as an optional component or accessory for a vehicle, and may be readily assembled to a common reflective element and/or mirror casing of the mirror assembly.

Optionally, the mirror casing and/or reflective element may include customized or personalized viewable characteristics, such as color or symbols or indicia selected by the vehicle manufacturer or owner of the vehicle, such as the customization characteristics described in U.S. Pat. Nos. 7,626,749; 7,255,451; 7,289,037, which are hereby incorporated herein by reference in their entireties.

Optionally, the mirror assembly may include other electrically operated or powered accessories, such as a compass sensor and compass display. Such a compass sensor and circuitry for the compass system that detects and displays the vehicle directional heading to a driver of the vehicle may comprise any suitable compass sensor and/or circuitry, such as a compass system and compass circuitry that utilizes aspects of the compass systems described in U.S. Pat. Nos. 7,370,983; 7,329,013; 7,289,037; 7,249,860; 7,004,593; 6,928,366; 6,642,851; 6,140,933; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; and/or 6,513,252, and/or European patent application, published Oct. 11, 2000 under Publication No. EP 0 1043566, and/or U.S. patent application Ser. No. 11/226,628, filed Sep. 14, 2005 and published Mar. 23, 2006 as U.S. Pat. Pub. No. US-2006-0061008, which are all hereby incorporated herein by reference in their entireties. The compass circuitry may include compass sensors, such as a magneto-responsive sensor, such as a magneto-resistive sensor, a magneto-capacitive sensor, a Hall sensor, a magneto-inductive sensor, a flux-gate sensor or the like. The compass sensor may be incorporated in or associated with a compass system and/or display system for displaying a directional heading of the vehicle to the driver, such as a compass system of the types described in U.S. Pat. Nos. 7,289,037; 5,924,212; 4,862,594; 4,937,945; 5,131,154; 5,255,442; 5,632,092; and/or 7,004,593, which are all hereby incorporated herein by reference in their entireties. Optionally, an integrated automotive “compass-on-a-chip” may be disposed in a cavity of the mounting base of the mirror (or within the mirror housing or in an attachment to the mirror mount or elsewhere within the mirror assembly such as to the rear of the video screen or to the rear of the mirror reflective element) and may comprise at least two sensor elements (such as magneto-responsive sensor elements, or a Hall effect sensor or multiple Hall effect sensors), associated A/D and D/A converters, associated microprocessor(s) and memory, associated signal processing and filtering, associated display driver and associated LIN/CAN BUS interface and the like, all (or a sub-set thereof) created or disposed or commonly established onto a semiconductor chip surface/substrate or silicon substrate, such as utilizing CMOS technology and/or fabrication techniques as known in the semiconductor manufacturing arts, and constituting an application specific integrated chip (“ASIC”), such as utilizing principles described in U.S. Pat. Nos. 7,815,326; 7,004,593; 7,329,013 and/or 7,370,983, and/or U.S. Pat. Pub. No. US-2006-0061008, which are hereby incorporated herein by reference in their entireties, and/or such as by utilizing aspects of an EC driver-on-a-chip such as described in U.S. Pat. No. 7,480,149, which is hereby incorporated herein by reference in its entirety.

Optionally, the mirror assembly and/or any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742; and/or 6,124,886, and/or U.S. Pat. Pub. No. US-2006-0050018, which are hereby incorporated herein by reference in their entireties.

Optionally, the mirror assembly may include one or more other accessories at or within the mirror casing, such as one or more electrical or electronic devices or accessories, such as antennas, including global positioning system (GPS) or cellular phone antennas, such as disclosed in U.S. Pat. No. 5,971,552, a communication module, such as disclosed in U.S. Pat. No. 5,798,688, a blind spot detection system, such as disclosed in U.S. Pat. Nos. 5,929,786 and/or 5,786,772, transmitters and/or receivers, such as a garage door opener or the like, a digital network, such as described in U.S. Pat. No. 5,798,575, a high/low headlamp controller, such as disclosed in U.S. Pat. Nos. 5,796,094 and/or 5,715,093, a memory mirror system, such as disclosed in U.S. Pat. No. 5,796,176, a hands-free phone attachment, a video device for internal cabin surveillance and/or video telephone function, such as disclosed in U.S. Pat. Nos. 5,760,962 and/or 5,877,897, a remote keyless entry receiver, lights, such as map reading lights or one or more other lights or illumination sources, such as disclosed in U.S. Pat. Nos. 6,690,268; 5,938,321; 5,813,745; 5,820,245; 5,673,994; 5,649,756; 5,178,448; 5,671,996; 4,646,210; 4,733,336; 4,807,096; 6,042,253; 5,669,698; 7,195,381; 6,971,775; and/or 7,249,860, microphones, such as disclosed in U.S. Pat. Nos. 7,657,052; 6,243,003; 6,278,377; and/or 6,420,975, speakers, antennas, including global positioning system (GPS) or cellular phone antennas, such as disclosed in U.S. Pat. No. 5,971,552, a communication module, such as disclosed in U.S. Pat. No. 5,798,688, a voice recorder, a blind spot detection system, such as disclosed in U.S. Pat. Nos. 7,720,580; 7,038,577; 6,882,287; 5,929,786 and/or 5,786,772, transmitters and/or receivers, such as for a garage door opener or a vehicle door unlocking system or the like (such as a remote keyless entry system), a digital network, such as described in U.S. Pat. No. 5,798,575, a high/low headlamp controller, such as a camera-based headlamp control, such as disclosed in U.S. Pat. Nos. 5,796,094 and/or 5,715,093, a memory mirror system, such as disclosed in U.S. Pat. No. 5,796,176, a hands-free phone attachment, an imaging system or components or circuitry or display thereof, such as an imaging and/or display system of the types described in U.S. Pat. Nos. 7,400,435; 7,526,103; 6,690,268 and/or 6,847,487, and/or U.S. Pat. Pub. No. US-2006-0125919, a video device for internal cabin surveillance (such as for sleep detection or driver drowsiness detection or the like) and/or video telephone function, such as disclosed in U.S. Pat. Nos. 5,760,962 and/or 5,877,897, a remote keyless entry receiver, a seat occupancy detector, a remote starter control, a yaw sensor, a clock, a carbon monoxide detector, status displays, such as displays that display a status of a door of the vehicle, a transmission selection (4 wd/2 wd or traction control (TCS) or the like), an antilock braking system, a road condition (that may warn the driver of icy road conditions) and/or the like, a trip computer, a tire pressure monitoring system (TPMS) receiver (such as described in U.S. Pat. Nos. 6,124,647; 6,294,989; 6,445,287; 6,472,979; 6,731,205 and/or 7,423,522, and/or an ONSTAR® system, a compass, such as disclosed in U.S. Pat. Nos. 5,924,212; 4,862,594; 4,937,945; 5,131,154; 5,255,442 and/or 5,632,092, and/or any other accessory or circuitry or the like (with all of the above-referenced patents and PCT and U.S. patent applications being commonly assigned and being hereby incorporated herein by reference in their entireties).

Optionally, the accessory or accessories, such as those described above and/or below, may be positioned at or within the mirror casing and/or mirror cap portion or the like, and may be included on or integrated in a printed circuit board positioned within the mirror casing and/or cap portion, such as along a rear surface of the reflective element or elsewhere within a cavity defined by the casing, without affecting the scope of the present invention. The connection or link between the controls and the display screen device and/or the navigation system and/or other systems and accessories of the mirror system may be provided via vehicle electronic or communication systems and the like, and may be connected via various protocols or nodes, such as BLUETOOTH®, SCP, UBP, J1850, CAN J2284, Fire Wire 1394, MOST, LIN, FlexRay™, Byte Flight and/or the like, or other vehicle-based or in-vehicle communication links or systems (such as WIFI and/or IRDA) and/or the like, or via VHF or UHF or other wireless transmission formats, depending on the particular application of the mirror/accessory system and the vehicle. Optionally, the connections or links may be provided via various wireless connectivity or links, without affecting the scope of the present invention.

Changes and modifications in the specifically described embodiments may be carried out without departing from the principles of the present invention, which is intended to be limited only by the scope of the appended claims as interpreted according to the principles of patent law.

1. An exterior rearview mirror assembly for a vehicle, said exterior rearview mirror assembly comprising:
a mirror reflective element comprises a glass substrate having a rear surface and a front surface that is closer to a driver of the vehicle than said rear surface when said exterior rearview mirror assembly is mounted at a vehicle;
wherein said mirror reflective element has an outboard region and an inboard region and wherein, when said exterior rearview mirror assembly is mounted at the vehicle, said inboard region is closer to the vehicle than said outboard region;
wherein said mirror reflective element comprises a generally planar principal reflecting portion and an angled reflecting portion and wherein said angled reflecting portion is established at said inboard region of said mirror reflective element;
wherein said angled reflecting portion is established by grinding a surface of said glass substrate at said inboard region;
wherein a mirror reflector is established at said angled reflecting portion;
wherein a mirror reflector is established at said principal reflecting portion; and
wherein said generally planar principal reflecting portion comprises a unit magnification principal reflecting portion of said mirror reflective element.

2. The exterior rearview mirror assembly of claim 1, wherein said angled reflecting portion is established by grinding said front surface of said glass substrate at said inboard region, and wherein said mirror reflector is established at the ground front surface of said glass substrate.

3. The exterior rearview mirror assembly of claim 2, wherein said angled reflecting portion comprises a curved front surface to provide a wider angle view at said inboard region.

4. The exterior rearview mirror assembly of claim 3, wherein said curved front surface comprises a convex curved front surface at said inboard region.

5. The exterior rearview mirror assembly of claim 3, wherein said mirror reflector is established at said front surface of said glass substrate at said principal reflecting portion.

6. The exterior rearview mirror assembly of claim 5, wherein said mirror reflector established at said principal reflecting portion and said mirror reflector established at said angled reflecting portion are commonly established.

7. The exterior rearview mirror assembly of claim 1, wherein said front surface of said glass substrate at said principal reflecting portion is unaffected by grinding said angled reflecting portion at said inboard region.

8. The exterior rearview mirror assembly of claim 1, comprising a camera adjustably disposed thereat and operable to capture image data.

9. The exterior rearview mirror assembly of claim 8, wherein said camera is adjustable to provide different fields of view for capturing image data representative of different scenes exterior of said exterior rearview mirror assembly.

10. The exterior rearview mirror assembly of claim 9, wherein said camera is adjustable responsive to a driving condition of the vehicle equipped with said camera.

11. The exterior rearview mirror assembly of claim 10, wherein, responsive to a signal indicative of the equipped vehicle being driven forwardly along a road, said camera is adjusted to have a generally rearward field of view with respect to the direction of travel of the equipped vehicle.

12. The exterior rearview mirror assembly of claim 10, wherein, responsive to a signal indicative of the equipped vehicle executing a parking maneuver, said camera is adjusted to have a generally downward field of view at the side of the equipped vehicle.

13. A method of making a mirror reflective element of an exterior rearview mirror assembly, said method comprising:
providing a mirror reflective element comprising a glass substrate having a rear surface and a front surface that is closer to a driver of the vehicle than said rear surface when said exterior rearview mirror assembly is mounted at a vehicle;
wherein said mirror reflective element has an outboard region and an inboard region and wherein, when said exterior rearview mirror assembly is mounted at the vehicle, said inboard region is closer to the vehicle than said outboard region;
wherein said mirror reflective element comprises a generally planar principal reflecting portion;
establishing an angled reflecting portion at said inboard region of said mirror reflective element;
wherein establishing an angled reflecting portion comprises establishing said angled reflecting portion by grinding a surface of said glass substrate at said inboard region;
establishing a mirror reflector at said angled reflecting portion; and
establishing a mirror reflector at said principal reflecting portion to provide a unit magnification principal reflecting portion of said mirror reflective element.

14. The method of claim 13, wherein establishing said angled reflecting portion comprises grinding said front surface of said glass substrate at said inboard region, and wherein establishing a mirror reflector at said angled reflecting portion comprises establishing a mirror reflector at the ground front surface of said glass substrate.

15. The method of claim 14, wherein said angled reflecting portion comprises a curved surface to provide a wider angle view at said inboard region.

16. The method of claim 15, wherein said curved surface comprises a convex curved surface at said inboard region.

17. The method of claim 15, wherein establishing a mirror reflector at said principal reflecting portion comprises establishing a mirror reflector at said front surface of said glass substrate at said principal reflecting portion.

18. The method of claim 17, wherein said mirror reflector established at said principal reflecting portion and said mirror reflector established at said angled reflecting portion are commonly established via a common mirror reflector coating process.

19. The method of claim 13, wherein said front surface of said glass substrate at said principal reflecting portion is unaffected by grinding said angled reflecting portion at said inboard region.

20. The method of claim 13, wherein establishing a mirror reflector at said principal reflecting portion and establishing a mirror reflector at said angled reflecting portion comprise commonly establishing a mirror reflector coating via a common mirror reflector coating process.
